(19) United States
(12) Patent Application Publication
(10) Pub. No.: US 2009/0286029 A1
(43) Pub. Date: Nov. 19, 2009

(54) Ethylene polymer composition

(75) Inventors: Pascale Godon, Bruxelles (BE); Daniel Libert, Court-St-Etienne (BE)

Correspondence Address: NIXON & VANDERHYE, PC, 901 NORTH GLEBE ROAD, 11TH FLOOR, ARLINGTON, VA, 22203, US

(73) Assignee: Ineos Manufacturing Belgium NV, Antwerpen (BE)

(21) Appl. No.: 12/308,666

(22) PCT Filed: Jul. 3, 2007
(86) PCT No.: PCT/EP2007/005873

§ 371 Date: Dec. 19, 2008

(30) Foreign Application Priority Data
Jul. 12, 2006 (EP) 06253646.1

(51) Int. Cl. C08L 23/06; B32B 1/08

(52) U.S. Cl. 428/36.9; 525/240

(57) ABSTRACT

A polyethylene composition is disclosed having an unpigmented density of at least 946 kg/m³ and a melt index MI₅ of 0.05 to 2 g/10 min, and comprising from 48 to 49.5% by weight based on the total weight of the composition of an ethylene polymer fraction (A) having a density of at least 969 kg/m³, and from 50.5 to 52% by weight with based on the total weight of the composition of a copolymer fraction (B) of ethylene and 1-hexene having a melt index MI₅ of 0.001 to 0.5 g/10 min and a density of no more than 930 kg/m³.

The present invention concerns a composition comprising an ethylene polymer and an ethylene copolymer, and its use for the manufacture of pipes. It also concerns a process of manufacture of that composition.

EP 897934A describes a composition comprising an ethylene polymer (A) with high melt index (MI₂ from 5 to 1000 g/10 min) and an ethylene and butene or hexene copolymer (B) with low melt index (MI₅ from 0.01 to 2 g/10 min), the ratio by weight of these polymers being (30 to 70):(70 to 30), preferably (42 to 58):(58 to 42). One example has an A:B block ratio of 50.8:49.2 and contains hexene as comonomer.

EP 1406967A discloses compositions comprising from 53 to 63% by weight of an ethylene polymer fraction (A) having a melt index MI₂ of at least 100 g/10 min, a density of at least 969 kg/m³, and from 37 to 47% by weight of a copolymer fraction (B) of ethylene and at least one alpha-olefin containing from 4 to 10 carbon atoms having a melt index MI₅ of 0.001 to 0.5 g/10 min, a density of no more than 930 kg/m³.

EP 1328580A discloses a composition made using a metallocene catalyst and comprising from 51 to 65 wt % of a polyethylene fraction of low molecular weight having a density of at least 0.969 g/cm³ and an MI₂ of greater than 100 g/10 min, and from 35 to 49 wt % of an ethylene polymer (B) comprising a linear low density polyethylene which may contain 1-hexene having a density of up to 0.928 g/cm³.

The compositions described in those patent applications generally have mechanical properties which render them appropriate for use in the manufacture of various formed objects, in particular pipes for the conveying of fluids under pressure, typically those intended to be buried underground in rock-free environments. The compositions explicitly described in those patent applications present mechanical properties, and more specifically a creep resistance, which make it possible to attribute to them a classification of MRS 8 or 10 according to standards ISO 9080 and ISO 12162. When these compositions are used for the manufacture of pipes with suitable dimensions, these pipes withstand certain pressures and certain temperatures which by extrapolation indicate that the pipes have at 20° C. a resistance to circumferential stresses respectively of at least 8 and 10 MPa for at least 50 years. There is always a demand for compositions having a better creep resistance so as to be able to manufacture pipes withstanding a still greater circumferential stress while maintaining or improving the other mechanical and utilisation properties, in particular resistance to slow propagation of cracks (ESCR) and resistance to rapid propagation of cracks (RCP).

We have found a specific composition which has particularly good mechanical properties such as ESCR.

Accordingly, in a first aspect the present invention provides a composition having an unpigmented density of at least 946 kg/m³ and a melt index MI₅ of 0.05 to 2 g/10 min, and comprising

from 48 to 49.5% by weight based on the total weight of the composition of an ethylene polymer fraction (A) having a density of at least 969 kg/m³, and

from 50.5 to 52% by weight with based on the total weight of the composition of a copolymer fraction (B) of ethylene and hexene having a melt index MI₅ of 0.001 to 0.5 g/10 min and a density of no more than 930 kg/m³.

For the purposes of the present invention, ethylene polymer (A) is an ethylene polymer comprising monomer units derived from ethylene and possibly monomer units derived from other olefins. Copolymer (B) is a copolymer comprising monomer units derived from ethylene and monomer units derived from 1-hexene.

Preferred amounts of ethylene polymer fraction (A) are from 48.2 to 49.2% by weight, preferably from 48.4 to 49% by weight. Preferred amounts of copolymer fraction (B) are 50.8 to 51.8% by weight, preferably from 51 to 51.6% by weight.

For the purposes of the present invention, alpha-olefin content is measured by RMN¹³C according to the method described in J. C. RANDALL, JMS-REV. MACROMOL. CHEM. PHYS., C29(2&3), p. 201-317 (1989). Thus the content of units derived from hexene is calculated from measurements of the integrals of the characteristic spectral lines of hexene (23.4; 34.9 and 38.1 ppm) with respect to the integral of the characteristic spectral line of the units derived from ethylene (30 ppm).

The content in copolymer (B) of monomer units derived from 1-hexene, hereinafter called 1-hexene content, is generally at least 0.5 mole %, in particular at least 0.8 mole %, values of at least 1 mole % being favourable. The 1-hexene content of copolymer (B) is usually at most 1.8 mole %, preferably at most 1.7 mole %. Particularly preferred is an 1-hexene content that does not exceed 1.5 mole %.

The 1-hexene content of the composition is preferably at least 0.4 mole %. The 1-hexene content of the composition preferably does not exceed 0.8 mole %.

Ethylene polymer (A) may possibly contain monomer units derived from another olefin. Ethylene polymer (A) comprises preferably at least 99.5, more particularly at least 99.8, mole % of monomer units derived from ethylene. Particularly preferred is an ethylene homopolymer.

For the purposes of the present invention, melt index MI₂ and MI₅ respectively mean the melt indices measured according to ASTM standard D 1238 (1986) at a temperature of 190° C. under a load of 2.16 kg and 5 kg respectively. Also, melt index HLMI means the melt index measured according to ASTM standard D 1238 (1986) at a temperature of 190° C. under a load of 21.6 kg.

Polymer (A) according to the invention preferably has an MI₂ of at least 200, preferably at least 250 g/10 min. The MI₂ of polymer (A) does not generally exceed 1000 g/10 min, preferably no more than 700 g/10 min. Polymer (A) preferably has an HLMI of at least 1000 g/10 min.

The melt index MI₅ of copolymer (B) according to the invention is preferably at least 0.005 g/10 min. It preferably does not exceed 0.1 g/10 min. Copolymer (B) presents advantageously an HLMI of at least 0.05 g/10 min which also does not exceed 2 g/10 min.

The composition according to the invention preferably has a melt index MI₅ of at least 0.07 g/10 min, preferably at least 0.1 g/10 min. The MI₅ of the composition does not usually exceed 1.5 g/10 min, preferably no more than 1 g/10 min. The composition according to the invention preferably has an HLMI of at least 1 g/10 min but preferably not more than 100 g/10 min.

The compositions according to the invention preferably have a density measured according to ASTM standard D 792 (on a sample prepared according to ASTM standard D 1928 Procedure C) of at least 945 kg/m³, more particularly at least 947 kg/m³. Preferably the density does not exceed 952 kg/m³. Particularly preferred are compositions whose density is below 951 kg/m³.

The density of the polymer (A) present in the compositions according to the invention is preferably at least 972 kg/m³. The density of copolymer (B) is preferably at least 910 kg/m³. The density of copolymer (B) does not exceed preferably 928 kg/m³, more particularly not 926 kg/m³. Densities referred to above are those of the unpigmented resin.

The composition according to the invention comprises generally at least 95%, preferably at least 99% by weight of the combination of polymer (A) and of copolymer (B). Particularly preferred is a composition consisting of polymer (A) and of copolymer (B) only.

The composition of the invention preferably comprises an intimate and homogeneous mixture of polymer (A) and of copolymer (B), copolymer (B) being prepared in the presence of polymer (A) or vice versa. Thus the composition comprises particles comprising both polymer (A) and copolymer (B).

In a further aspect, the invention provides a process for making the above composition, wherein, in at least two polymerisation reactors connected in series, the following steps are performed:
in a first reactor, ethylene is polymerised in suspension in a medium comprising a diluent, hydrogen, a catalyst based on a transition metal and a cocatalyst so as to form ethylene polymer (A),
said polymer (A) and some ethylene and at least one other α-olefin containing from 4 to 10 carbon atoms are introduced into a further reactor and polymerisation in suspension is performed therein in order to form from ethylene copolymer (B),

wherein the catalyst utilised in both steps is a Ziegler-Natta catalyst comprising
from 10 to 30%, preferably from 15 to 20%, by weight of transition metal,
from 0.5 to 20%, preferably from 1 to 10%, by weight of magnesium,
from 20 to 60%, preferably from 30 to 50%, by weight of halogen,
from 0.1 to 10%, preferably from 0.5 to 5%, by weight of aluminium.

The preferred manufacturing process is performed in at least two polymerisation reactors connected in series, according to which preferred process:
in a first reactor, ethylene is polymerised in suspension in a medium comprising a diluent, hydrogen, a catalyst as defined above and a cocatalyst so as to form ethylene polymer (A),
said medium comprising polymer (A) in addition is drawn off from said reactor and is subjected to expansion so as to degas at least part of the hydrogen, after which
said at least partially degassed medium comprising polymer (A) and some ethylene and 1-hexene are introduced into a further reactor in which polymerisation in suspension is effected in order to form ethylene copolymer (B).

Polymerisation in suspension means polymerisation in a diluent which is in the liquid state in the polymerisation conditions (temperature, pressure) used, these polymerisation conditions or the diluent being such that at least 50% by weight (preferably at least 70%) of the polymer formed is insoluble in said diluent.

The diluent used in this polymerisation process is usually a hydrocarbon diluent, inert to the catalyst, to the cocatalyst and to the polymer formed, such for example as a linear or branched alkane or a cycloalkane, having from 3 to 8 carbon atoms, such as hexane or isobutane.

The quantity of hydrogen introduced into the first reactor is in general set so as to obtain, in the diluent, a molar ratio between hydrogen and ethylene of 0.05 to 1. In the first reactor, this molar ratio is preferably at least 0.1. Particularly preferred is a hydrogen/ethylene molar ratio that does not exceed 0.6.

The medium drawn off from the first reactor comprising in addition the polymer (A) is subjected to expansion so as to eliminate (degas) at least part of the hydrogen. The expansion is advantageously effected at a temperature below or equal to the polymerisation temperature in the first reactor. The temperature at which the expansion is effected is usually greater than 20° C., it is preferably at least 40° C. The pressure at which the expansion is carried out is below the pressure in the first reactor. The expansion pressure is preferably below 1.5 MPa. The expansion pressure is usually at least 0.1 MPa. The quantity of hydrogen still present in the at least partially degassed medium is generally below 1% by weight of the quantity of hydrogen initially present in the medium drawn off from the first polymerisation reactor, this quantity is preferably below 0.5%. The quantity of hydrogen present in the partially degassed medium introduced into the further polymerisation reactor is therefore low or even nil. The further reactor is preferably also supplied with hydrogen. The quantity of hydrogen introduced into the further reactor is in general set so as to obtain, in the diluent, a molar ratio between hydrogen and ethylene of 0.001 to 0.1. In this further reactor, this molar ratio is preferably at least 0.004. It does not exceed preferably 0.05. In the process according to the invention, the ratio between the hydrogen concentration in the diluent in the first reactor and that in the further polymerisation reactor is usually at least 20, preferably at least 30. Particularly preferred is a ratio of concentrations of at least 40. This ratio does not usually exceed 300, preferably not 200.

The quantity of 1-hexene introduced into the further polymerisation reactor is such that in that reactor the 1-hexene/ethylene molar ratio in the diluent is at least 0.05, preferably at least 0.1; preferably it does not exceed 3, and is more preferably no higher than 2.8.

The catalyst used in this process comprises at least one transition metal. Transition metal means a metal of groups 4, 5 or 6 of the Periodic Table of elements (CRC Handbook of Chemistry and Physics, 75th edition, 1994-95). The transition metal is preferably titanium and/or zirconium. A catalyst comprising not only the transition metal but also magnesium is preferably utilised. Good results have been obtained with catalysts comprising:
from 10 to 30%, preferably from 15 to 20%, by weight of transition metal,
from 0.5 to 20%, preferably from 1 to 10%, by weight of magnesium,
from 20 to 60%, preferably from 30 to 50%, by weight of halogen, such as chlorine,
from 0.1 to 10%, preferably from 0.5 to 5%, by weight of aluminium; the balance generally consisting of elements arising from products used for their manufacture, such as carbon, hydrogen and oxygen. These catalysts are preferably obtained by coprecipitation of at least one transition metal composition and a magnesium composition by means of a halogenated organoaluminium composition. Such catalysts are known, they have notably been described in U.S. Pat. No. 3,901,863, U.S. Pat. No. 42,942,200 and U.S. Pat. No. 4,617,360. The catalyst is preferably introduced only into the first polymerisation reactor, i.e. there is no introduction of fresh catalyst into the further polymerisation reactor.

The cocatalyst utilised in the process is preferably an organoaluminium compound. Unhalogenated organoaluminium compounds of formula AIR₃ in which R represents an alkyl grouping having from 1 to 8 carbon atoms are preferred. Particularly preferred are triethylaluminium and triisobutylaluminium. The cocatalyst is introduced into the first polymerisation reactor. Fresh cocatalyst may also be introduced into the further reactor. The quantity of cocatalyst introduced into the first reactor is in general at least 0.1×10⁻³ mole per litre of diluent. It does not usually exceed 5×10⁻³ mole per litre of diluent. Any quantity of fresh cocatalyst introduced into the further reactor does not usually exceed 5×10⁻³ mole per litre of diluent.

The polymerisation temperature is generally from 20 to 130° C. It is preferably at least 60° C. For preference, it does not exceed 115° C. The total pressure at which the process is effected is in general from 0.1 MPa to 10 MPa. In the first polymerisation reactor, the total pressure is preferably at least 2.5 MPa. Preferably, it does not exceed 5 MPa. In the further polymerisation reactor, the total pressure is preferably at least 1.3 MPa. Preferably, it does not exceed 4.3 MPa.

The period of polymerisation in the first reactor and in the further reactor is in general at least 20 minutes, preferably at least 30 minutes. It does not usually exceed 5 hours, preferably not 3 hours.

In this process, a suspension comprising the composition of the invention is collected at the outlet of the further polymerisation reactor. The composition may be separated from the suspension by any known means. Usually, the suspension is subjected to a pressure expansion (final expansion) so as to eliminate the diluent, the ethylene, the alpha-olefin and any hydrogen from the composition.

This process makes it possible to obtain, with a good yield and with a low oligomers content, a composition having a very good compromise between mechanical properties and utilisation properties.

The compositions of the invention are well suited to the manufacture of pipes, particularly pipes for the conveying of fluids under pressure, such as water and gas. The invention therefore also concerns the use of a composition according to the invention for the manufacture of pipes. Naturally, when they are used for the molten forming of articles, and more particularly for the manufacture of pipes, the compositions of the invention may be mixed with the usual additives for utilisation of polyolefins, such as stabilisers (antioxidant agents, anti-acids and/or anti-UVs), antistatic agents and utilisation agents (“processing aid”), and pigments. The invention therefore concerns also a mixture comprising a composition according to the invention and at least one of the additives described above. Particularly preferred are mixtures comprising at least 95%, preferably at least 97%, by weight of a composition according to the invention and at least one of the additives described above. The manufacture of pipes by extrusion of a composition according to the invention is preferably carried out on an extrusion line comprising an extruder, a sizer and a drawing device. Extrusion is generally performed on an extruder of the single-screw type and at a temperature of 150 to 230° C. The sizing of the pipes may be effected by the creation of negative pressure outside the pipe and/or by the creation of positive pressure inside the pipe.

Pipes manufactured by means of the compositions according to the invention are characterised by:
good resistance to slow propagation of cracks (FNCT), reflected by a rupture time, as measured by the method described in the standard undergoing preparation ISO/DIS 16770.2 (2001) (at 80° C., under a stress of 4.0 MPa (in an Arkopal N110 2% solution)), generally greater than 100 hours. Typically, under conditions of 80° C. and 4 MPa in 2% Arkopal N100 the compositions of the invention give FNCT results greater than 7000 hours.
good resistance to rapid propagation of cracks (RCP), reflected by a halting of crack propagation at an internal pressure generally equal to at least 10 bar, as measured at 0° C. on a pipe of diameter 110 mm and thickness 10 mm according to method S4 described in ISO standard F/DIS 13477 (1996);
good long-term pressure resistance which enables them to be attributed a higher MRS rating than the MRS 10 rating according to standard ISO/TR 9080. Typically, the pipes manufactured from a composition of the invention have a pressure resistance that enables them to be attributed an MRS rating of 10 according to standard ISO/TR 9080.

Pipes manufactured from the compositions of the invention are characterised in particular by a good compromise between resistance to rapid crack propagation and creep resistance combined to an exceptional stress crack resistance (slow crack propagation resistance) compared with compositions known from the prior art. The invention therefore also concerns pipes (more particularly pipes for the conveying of fluids under pressure) obtained by extrusion of a composition according to the invention.

The following examples are intended to illustrate the invention.

The meaning of the symbols used in these examples and the units expressing the parameters mentioned and the methods of measuring those parameters are explained below.

Q=comonomer content of copolymer (B), expressed in mole %, measured as described above.
QT=comonomer content of the composition, expressed in mole %. This content is measured as explained above for the comonomer content of copolymer (B).

The other symbols are explained in the description.

The values marked * were calculated from measured values for the polymer manufactured in reactor 1 and the composition leaving reactor 2.

### EXAMPLE 1

### a) Preparation of the Catalyst

Magnesium diethylate was caused to react for 4 hours at 150° C. with titanium tetrabutylate in quantities such that the molar ratio of titanium to magnesium was equal to 2. Thereafter the reaction product thus obtained was chlorinated and precipitated by placing it in contact with an ethylaluminium dichloride solution for 90 minutes at 45° C. The catalyst thus obtained, gathered from the suspension, comprised (% by weight): Ti:17; Cl:41; Al:2; Mg:5.

### b) Preparation of the Composition

The manufacture of a composition comprising ethylene polymers was carried out in suspension in isobutane in two loop reactors connected in series and separated by a device which makes it possible continuously to carry out the reduction in pressure.

Isobutane, ethylene, hydrogen, triethylaluminium and one of the catalysts (1) or (II) above were continuously introduced into the first loop reactor and the polymerization of ethylene was carried out in this mixture in order to form the homopolymer (A). This mixture, additionally comprising the homopolymer (A), was continuously withdrawn from the said reactor and was subjected to a reduction in pressure (˜50° C., 0.6 MPa), so as to remove at least a portion of the hydrogen. The resulting mixture, at least partially degassed of hydrogen, was then continuously introduced into a second polymerization reactor, at the same time as ethylene, hexene, isobutane and hydrogen, and the polymerization of the ethylene and of the hexene was carried out therein in order to form the ethylene/1-hexene copolymer (B). The suspension comprising the composition comprising ethylene polymers was continuously withdrawn from the second reactor and this suspension was subjected to a final reduction in pressure, so as to evaporate the isobutane and the reactants present (ethylene, hexene and hydrogen) and to recover the composition in the form of a powder, which was subjected to drying in order to complete the degassing of the isobutane.

The other polymerisation conditions are specified in Table 1.

The polymers thus obtained were then compounded, optionally with pigment, to make a number of resins as specified in Table 2.

### c) Preparation of Pipes

The various polymers were then converted into pipes by a standard HDPE extrusion process using a Battenfelt and Krauss Maffei extruder. Process conditions were chosen so as to avoid degradation and oxidation, as is well-known to those skilled in the art. The extrusion was performed with a barrier screw having an L/D ratio of 25-30, including a grooved feeding section, and a mixing and compression section. Output was kept below 85% of the maximum output of the extruder, so as to ensure good welding between the molten streams at the exit of the extruder head.

The temperature profile was:

| | |
|---|---|
| Feeding area | 50° C. |
| Cylinder temperature | 180-205° C. |
| Head temperature | 205-210° C. |
| Die temperature | 205-210° C. |
| Melt temperature | 200-220° C. |

A number of identical pipes were made in order to provide multiple samples for testing.

TABLE 1
Reactor 1

| | |
|---|---|
| C₂ (mole %) | 2.5 |
| H₂/C₂ mole ratio | 0.43 |
| T (° C.) | 95 |
| dwell time (h) | 2 |

Reactor 2

| | |
|---|---|
| C₂ (mole %) | 1.5 |
| H₂/C₂ mole ratio | <0.015 |
| C₆/C₂ mole ratio | 1.3 |
| T (° C.) | 85 |
| dwell time (h) | 0.54 |

TABLE 2
Properties of product produced in reactor 1

| | |
|---|---|
| p1 (wt %) | 48 |
| MI₂ (g/10 min)^{#} | 25 |
| Density (kg/m³) | 973 |

Properties of final pelletized product

| Colour | Black | Blue | Orange |
|---|---|---|---|
| MI₅ (g/10 min) | 0.32 | 0.34 | 0.33 |
| I₂₁ (g/10 min) | 9.9 | 9.7 | 9.7 |
| μ₂ (1000 Pa · s) | 20800 | 20300 | 20400 |
| Mz/Mw | 30.2 | | |
| Mw/Mn | 4.9 | | |
| Density (kg/m³)* | 957.5 | 952.9 | 952.1 |

^{#}MI₂ measured with 8 mm length/1.0 mm internal diameter die, which gives values approximately 19 times lower than an 8 mm/2.095 mm die
*including pigment

### Mechanical Properties

Several identical pipes were made with each resin for testing.

### Creep Resistance

Creep resistance was evaluated on 32 mm SDR 11 pipes produced on KM and/or Battenfeld extruders according to ISO 1167. The pressure tests results are on the basis of an MRS rating equal to 10 MPa, according to the standard ISO9080.

### Stress Crack Resistance

Stress crack resistance was evaluated with 3 different tests
Notch pipe tests, diameter 110 mm, SDR 11 according to ISO13479
Point loading test:
   The point loading test, at constant deformation with a smooth stamp, was developed by Hessel Ingenieurtechnik GmbH, and is a hydrostatic pressure test on a pipes subjected to a constant wall deformation due to a point load. A pipe of 110 mm, SDR 11, under a constant pressure of 4 MPa, is immersed in a 80° C. mixture of water+2% w/w Arkopal N100. The pipe is externally loaded by compression with a smooth 10 mm diameter steel ball. The force applied on the ball is increased until a 5 mm horizontal flattening of the inner surface of the pipe wall is obtained. This deformation is then maintained constant. The time to failure and the failure mode (only brittle failure in the point load area is to be considered) are recorded.

FNCT test:

As described in ISO DIS 16770 standard. Six hollow tubes of square cross-section (10×10×100 mm), cut-out on moulded plates, are notched in their mid-length on all four sides (perpendicularly to the further tensile stress direction) with a very sharp razor blade; the notches are 1.6 mm deep. Notched samples are then inunersed in a stirred mixture of water+2% w/w Arkopal N100 at 80° C., under a constant load of 4 MPa. The failure type and mode (brittle failure must be observed for a representative stress crack resistance test) are recorded.

### Rapid Crack Propagation

Rapid crack propagation was determined at an internal pressure generally equal to at least 10 bars, as measured at 0° C. on a pipe of diameter 110 mm and thickness 10 mm according to method S4 described in ISO13477.

TABLE 3

| | | | |
|---|---|---|---|
| EXAMPLE | Black | Blue | Orange |

Creep

| | | | |
|---|---|---|---|
| Pipe 1 - 12.4 MPa- 20° C. | 178.05 | 404 | 220.97 |
| Pipe 2 - 12.4 MPa- 20° C. | 167.91 | 298 | 267.9 |
| Pipe 3 - 12.4 MPa- 20° C. | 149.42 | 366 | 244.69 |
| Pipe 1 - 5.5 Mpa- 80° C. | 4078.14 | 3325 | >5000 |
| Pipe 2 - 5.5 MPa- 80° C. | 3136.19 | 2465 | >5000 |
| Pipe 3 - 5.5 MPa- 80° C. | 2500.47 | 5506 | >5000 |
| Pipe 1/2/3 - 5.0 MPa- 80° C. | >15000 | >6000 | >5000 |
| 50-years (σ LPL) at 20° C. - Confidence Limit | 10.324 | 10.69 | 10.529 |
| 97.5% - MPa | | | |

Stress crack resistance
Notch pipe test - 110 mm SDR 11 pipes - 9.2 bar, 80° C.

| | | | |
|---|---|---|---|
| Pipe 1 | 7521 | 11463 | >8350 |
| Pipe 2 | 7538 | >9950 | >8350 |
| Pipe 3 | 8499 | >13591 | >8350 |
| Pipe 4 | 8762 | | |
| Pipe 5 | 8884 | | |

Point loading test - 110 mm SDR 11 pipes- 4 MPa - 80° C. - Arkopal N100

| | | |
|---|---|---|
| >8880 | >8900 | >8880 |

FNCT- 4 MPa - 80° C. - Arkopal N100

| | | | |
|---|---|---|---|
| All specimens | >11300 | >15200 | >13000 |

Rapid crack propagation

| | |
|---|---|
| 250 mm SDR 11 | 110 mm SDR 11 |

| | | | |
|---|---|---|---|
| 0° C. | >20 bars | >10 | >10 |
| −5° C. | | >10 | >10 |
| −10° C. | | >10 | >10 |
| −15° C. | | >10 | 9 |

It can be seen from the above table that all the resins pass the European requirements (EN1555-EN12201-ISO4427-ISO4437) for creep resistance of a PE100 resin
At least 100 hours at 12.4 MPa, 20° C.
At least 165 hours at 5.5 MPa, 80° C. without brittle failure
At least 1000 hours at 5 MPa, 80° C.
LPL>10 MPa
   For stress crack resistance, all of the resins superseded considerably the requirements (EN1555-EN12201-ISO4427-ISO4437) for a PE100 resin, concerning the notch pipe test (>at 165 hours at 80° C., 9.2 Bars)
   The excellent behaviour of these resins in term of stress crack resistance, is also put in evidence by the point loading tests and FNCT tests (classical PE100 presents results around 300 hours for point loading, and 500 hours in for FNCT, at 4 MPa, 80° C., in Arkopal N100)
   All the resins show good resistance to rapid crack propagation (RCP).

1-11. (canceled)

12. Composition having an unpigmented density of at least 946 kg/m³ and a melt index MI₅ of 0.05 to 2 g/10 min, and comprising
from 48 to 49.5% by weight based on the total weight of the composition of an ethylene polymer fraction (A) having a density of at least 969 kg/m³, and
from 50.5 to 52% by weight with based on the total weight of the composition of a copolymer fraction (B) of ethylene and 1-hexene having a melt index MI₅ of 0.001 to 0.5 g/10 min and a density of no more than 930 kg/m³.

13. Composition according to claim 12, characterised in that it has an unpigmented density between 947 kg/m³ and 951 kg/m³.

14. Composition according to claim 12, wherein the 1-hexene content composition is from 0.4 to 0.8 mol %.

15. Composition according to claim 12, wherein the 1-hexene content of copolymer fraction (B) is from 1 to 1.5 mol %.

16. Composition according to claim 12, characterised in that it has an MI₅ of 0.1-1 g/10 min, preferably 0.2-0.5 g/10 min.

17. Pipe made from a composition as defined in claim 12, which has an FNCT, reflected by a rupture time as measured by the method described in the standard undergoing preparation ISO/DIS 16770.2 (2001) (at 80° C., under a stress of 4.0 MPa (in an Arkopal N100 2% solution)), of greater than 7000 hours.

18. Pipe according to claim 17, which has an MRS rating of 10 or better according to standard ISO/TR 9080.

19. Process for preparing a composition as defined in claim 12, wherein, in at least two polymerisation reactors connected in series, the following steps are performed:
in a first reactor, ethylene is polymerised in suspension in a medium comprising a diluent, hydrogen, a catalyst based on a transition metal and a cocatalyst so as to form ethylene polymer (A),
said polymer (A) and some ethylene and at least one other α-olefin containing from 4 to 10 carbon atoms are introduced into a further reactor and polymerisation in suspension is performed therein in order to form from ethylene copolymer (B),
wherein the catalyst utilised in both steps is a Ziegler-Natta catalyst comprising
from 10 to 30%, preferably from 15 to 20%, by weight of transition metal,
from 0.5 to 20%, preferably from 1 to 10%, by weight of magnesium,
from 20 to 60%, preferably from 30 to 50%, by weight of halogen,
from 0.1 to 10%, preferably from 0.5 to 5%, by weight of aluminium.

20. Process according to claim 19, wherein the catalyst contains from 15 to 20% by weight of transition metal, from 1 to 10% by weight of magnesium, from 30 to 50% by weight of chlorine and from 0.5 to 5% by weight of aluminium.

21. Process for the manufacture of pipes, comprising extruding a composition according to claim 12 or formed by a process as defined above.

22. Use of a composition as defined in claim 12 for the manufacture of pipes.
